(19) United States
(12) Patent Application Publication
(10) Pub. No.: US 2018/0209835 A1
(43) Pub. Date: Jul. 26, 2018

(54) METHOD FOR MEASURING FILL LEVEL OF A FILL SUBSTANCE LOCATED IN A CONTAINER

(71) Applicant: ENDRESS+HAUSER GMBH+CO. KG, Maulburg (DE)

(72) Inventors: Thomas Blödt, Steinen (DE); Peter Klöfer, Steinen (DE); Maik Weishaar, Bonndorf (DE)

(21) Appl. No.: 15/758,427

(22) PCT Filed: Jun. 22, 2016
(86) PCT No.: PCT/EP2016/064362

§ 371 Date: Mar. 8, 2018

(30) Foreign Application Priority Data
Sep. 14, 2015 (DE) 10 2015 115 462.5

(51) Int. Cl. G01F 23/284; G01S 13/88; G01S 13/12; G01S 7/292

(52) U.S. Cl. CPC G01F 23/284; G01S 7/292; G01S 13/12; G01S 13/88

(57) ABSTRACT

The invention relates to a method for measuring fill level of a substance in a container. The method is based on pulse radar in which the repetition frequency of the microwave pulse is not constant but is controlled as a function of travel time. The repetition frequency increases as the travel time becomes shorter and lessens as the travel time becomes longer. The fill level is not based on the measured travel time, but is determined based on the resulting repetition frequency. The invention provides a pulse radar-based method for fill level measurement that can be implemented with reduced circuit complexity. This results from the fact that only the repetition frequency needs to be registered for fill level measurement. Neither a complex analog evaluating circuit nor a highly accurate time measurement are required. Complex digital data processing, such as the FMCW-based method required for fill level measurement, is absent.

The invention relates to a method for measuring fill level of a fill substance located in a container by means of microwave pulses, as well as to a fill-level measuring device suitable for performing such method.

In automation technology, especially in process automation-technology, field devices are often applied, which serve for registering and/or influencing process variables. Serving for registering process variables are sensors, which are integrated in, for example, fill level measuring devices, flow measuring devices, pressure and temperature measuring devices, pH and redox potential measuring devices, conductivity measuring devices, etc., which register the corresponding process variables, fill level, flow, pressure, temperature, pH-value, redox potential, and conductivity. Serving for influencing process variables are actuators, such as, for example, valves or pumps, via which the flow of a liquid in a pipeline section, or the fill level in a container, can be changed. Referred to as field devices are, in principle, all devices, which are applied near to the process and which deliver, or process, process relevant information. In connection with the invention, the terminology, field devices, thus refers also to remote I/Os, radio adapters, and, generally, electronic components, which are arranged at the field level. A large number of such field devices are produced and sold by the firm, Endress+Hauser.

Contactless measuring methods are increasingly used for fill level measurement, since they are robust and low-maintenance. A further advantage is their ability to measure steplessly. Here, special radar-based measuring methods, which work according to the pulse travel-time principle, have become common. In the case of this measuring method, which is also known under the name, pulse radar, short microwave pulses are periodically sent toward the fill substance with a predefined repetition frequency, e.g. in an order of magnitude of 1 to 2 MHz, and eigenfrequencies in the giga hertz range. Their signal fractions reflected back in the direction of the transmitting and receiving system are then received after a travel time dependent on the path traveled in the container.

Due to the high propagation velocity of the pulses with the speed of light, however, a very fast and therewith very complex counter in combination with a circuit-wise complicated statistics is required, since the travel time is small in the range of nanoseconds to microseconds. A fill-level measuring device working according to such a principle is described, for example, in the patent, DE 10 2004 035757 B3.

In order to be able to omit a correspondingly complex counter, a time expansion of the reflected signal can be performed by sampling the received signal. Thus, a time expansion of the received signal can be effected by a factor of up to 10⁵. In this way, the requirements for the counter can be drastically reduced.

Such a method of time expansion represents, in the meantime, the standard method in the field of pulse radar-based fill level measurement. A corresponding method is described, for example, in the publication, EP 1 324 067 A2. As can be learned therefrom, the resulting signal is usually subsequently rectified and fed via a low-pass filter and an analog-digital converter to an evaluation unit. There, based on the resulting signal, the travel time of the microwave pulses is ascertained. Disadvantageous with such a method is, however, its complex circuitry, in the case of which, above all, the time expansion and the evaluation of the envelope curve are considerable.

An object of the invention, therefore, is to provide a radar-based method for fill level measurement, which can be implemented with less complicated circuitry.

The invention achieves this object by a method for measuring fill level of a fill substance located in a container by means of microwave pulses. The method includes method steps as follows:
A microwave pulse is transmitted toward the fill substance,
the microwave pulse is reflected on the surface of the fill substance,
the reflected microwave pulse is received after a travel time dependent on the fill level.

In such case, the method steps of the invention are cyclically repeated with a repetition frequency, wherein the repetition frequency is controlled as a function of travel time in such a manner that repetition frequency increases in the case of travel time becoming shorter and lessens in the case of travel time becoming longer. Fill level is determined based on the repetition frequency.

In contrast to the classic pulse radar method, fill level is determined in the case of the method of the invention not based on the measured travel time, but, instead, based on the resulting repetition frequency, with which the microwave pulses are transmitted. The repetition frequency is set according to the invention by triggering the transmission of a microwave pulse by the last received microwave pulse. From this there results the advantage that only the repetition frequency needs to be registered for fill level determination. Required in contrast to the classic pulse radar method are neither a highly accurate time measurement nor a complex analog evaluating circuit. Also, a complex digital data processing, such as is required in the case of the FMCW-based method for fill level measurement, can be omitted.

In a first embodiment, the repetition frequency is directly proportional to the reciprocal of travel time. In this way, the transmission of a microwave pulse is triggered without time delay upon receipt of the microwave pulse last reflected on the surface of the fill substance. To the extent that the signal travel time within the fill-level measuring device is neglected, the distance is determined in the case of this embodiment directly from the reciprocal of the ascertained frequency multiplied by the propagation velocity.

Alternatively, the repetition frequency is proportional to the reciprocal of the sum of travel time and a predefined time delay. In this way, it is possible to mask out the near range of the fill-level measuring device. Thus, disturbance echos coming from there can be masked out. The depth of the masked out, near range depends, in such case, on the length of the time delay.

In an advantageous form of the method of the invention, for starting the measuring or for the case, in which no microwave pulse reflected on the surface of the fill substance is received within a predetermined maximum time interval, an initiating microwave pulse is transmitted toward the fill substance. In this way, it is prevented that in these cases the measuring stops. Thus, also without received microwave pulse, the triggering of an additional microwave pulse is initiated.

Additionally advantageous is when it is supplementally checked whether the received microwave pulse is the microwave pulse reflected on the surface of the fill substance. This is done by ascertaining the signal strength of the received microwave pulse. In such case, the received microwave pulse is filtered out, when the signal strength lies outside a predefined range. This predefined range can be ascertained, for example, by one or more calibration measurements, in the case of which the signal strength is measured e.g. in the case of completely empty or completely full container.

Moreover, in an additional form of embodiment of the method, it can be checked whether the received microwave pulse is the microwave pulse reflected on the surface of the fill substance, wherein
a second microwave pulse is transmitted at the same time as the first microwave pulse toward the fill substance,
the second microwave pulse is reflected on the surface of the fill substance,
the reflected second microwave pulse is received after a travel time dependent on the fill level,
the travel time of the second microwave pulse is compared with the travel time of the first microwave pulse.

In such case, when the travel time of the second microwave pulse does not approximately correspond to the travel time of the first microwave pulse, the received microwave pulse is filtered out. Such microwave pulses to be filtered can be brought about, for example, by disturbing bodies within the container or by multi-echos. A corresponding filtering prevents that an incorrect fill level value is ascertained due to such microwave pulses.

In order to suppress overdriving in the case of strongly reflected microwave pulses, and in order in the case of weakly reflected microwave pulses to assure a sufficient signal strength, it is additionally advantageous that the microwave pulse to be transmitted and/or the reflected microwave pulse be amplified in such a manner that the amplification is increased in the case of repetition frequency becoming lower, and that the amplification is lessened in the case of repetition frequency becoming higher. This type of control contributes, moreover, to a lessened power consumption by the fill-level measuring device. This is relevant especially in the case of field devices in process automation having very high requirements for explosion safety, whereby the maximum allowed power consumption is strongly limited. This advantageous type of amplification can thus, for example, decisively assure that the fill-level measuring device conforms to the explosion protection regulations according to the relevant family of standards, EN 60079-0:2009.

The object of the invention is additionally achieved by a fill-level measuring device for performing the method described in at least one of the preceding claims. For this, the fill-level measuring device includes:
a pulse producing unit for cyclic production of microwave pulses,
at least one antenna unit for transmitting and/or receiving microwave pulses,
a detector unit for detecting the reflected microwave pulses,
a trigger for clocked triggering of the pulse producing unit as a function of travel time, and
an evaluating unit for determining the repetition frequency.

Advantageously, the fill-level measuring device includes, furthermore, a modulation unit, which delays triggering of the pulse producing unit by a delay time. By means of the modulation unit, it is possible to mask out the near range, wherein the depth of the near range conforms to the length of the time delay. In such case, the time delay can be a predefined time delay. The modulation unit can, however, also be based on masking out certain time segments in the form of the received signal within the transmitting cycle in the form of a delay time. Technically, a predefined time delay can be implemented in analog manner by logarithmic connecting in of line portions or by digital conversion.

Alternatively, the modulation unit can be implemented by means of a flip-flop based circuit or a pulse gate-based circuit. This enables a timed attenuation or a complete masking of the received signal received from the antenna unit 4.

For initiating triggering of the pulse producing unit, the fill-level measuring device includes in a further form of embodiment an initial trigger. This serves for transmitting an initiating microwave pulse toward the fill substance, in order to start the measuring or for the case, in which no microwave pulse reflected on the surface of the fill substance is received within a predetermined maximum time interval.

In an additional advantageous form of embodiment of the fill-level measuring device, at least one filter unit is provided, which tests according to one of the previously described methods whether the received microwave pulse is the microwave pulse reflected on the surface of the fill substance. In this way, it is prevented according to the method of the invention that an incorrect fill level value is ascertained due to received microwave pulses, which have not been brought about by reflection on the surface of the fill substance.

For an improved detecting of the received microwave pulses, it is additionally advantageous that the fill-level measuring device includes at least one amplifier for amplifying the microwave pulses to be transmitted and/or the reflected microwave pulses. In such case, it is especially advantageous that the amplifier amplifies the reflected microwave pulses in such a manner that the amplification is increased in the case of repetition frequency becoming lower, and that the amplification is lessened in the case of repetition frequency becoming higher. In this way, an overdriving of the received microwave pulses can be suppressed, when these are reflected very strongly due to high fill levels. Likewise this assures a sufficient signal strength in the case of low fill levels and accordingly weakly reflected microwave pulses.

The invention will now be explained based on the appended drawing, the figures of which show as follows:

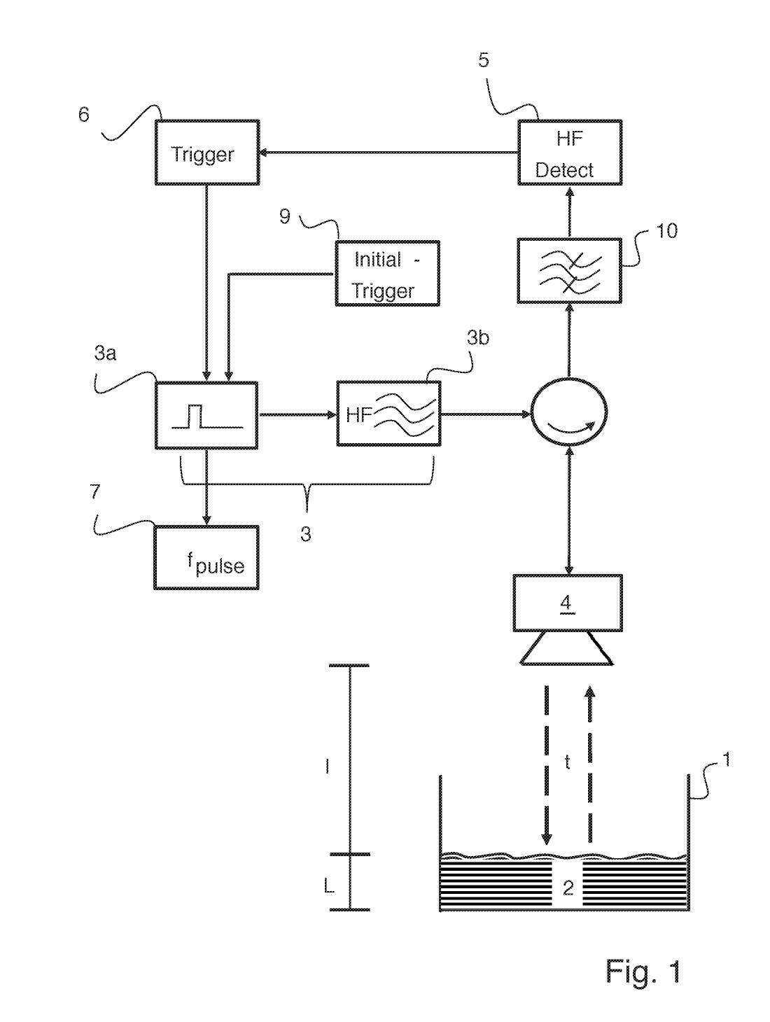

FIG. 1 a block diagram of a fill-level measuring device of the invention,

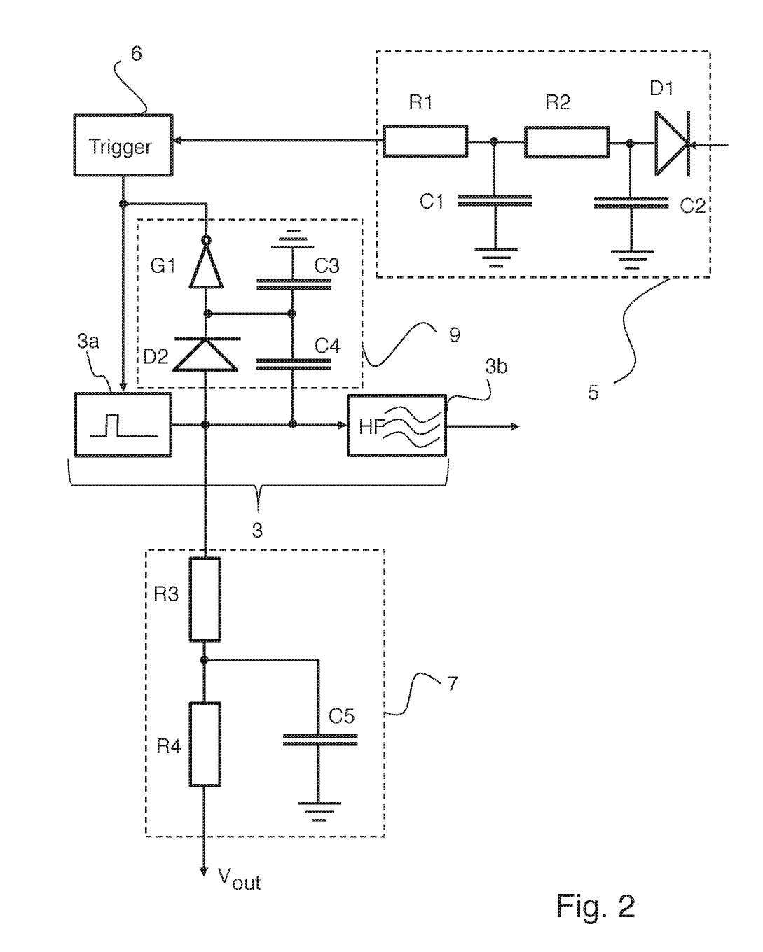

FIG. 2 detailed portions of the block diagram,

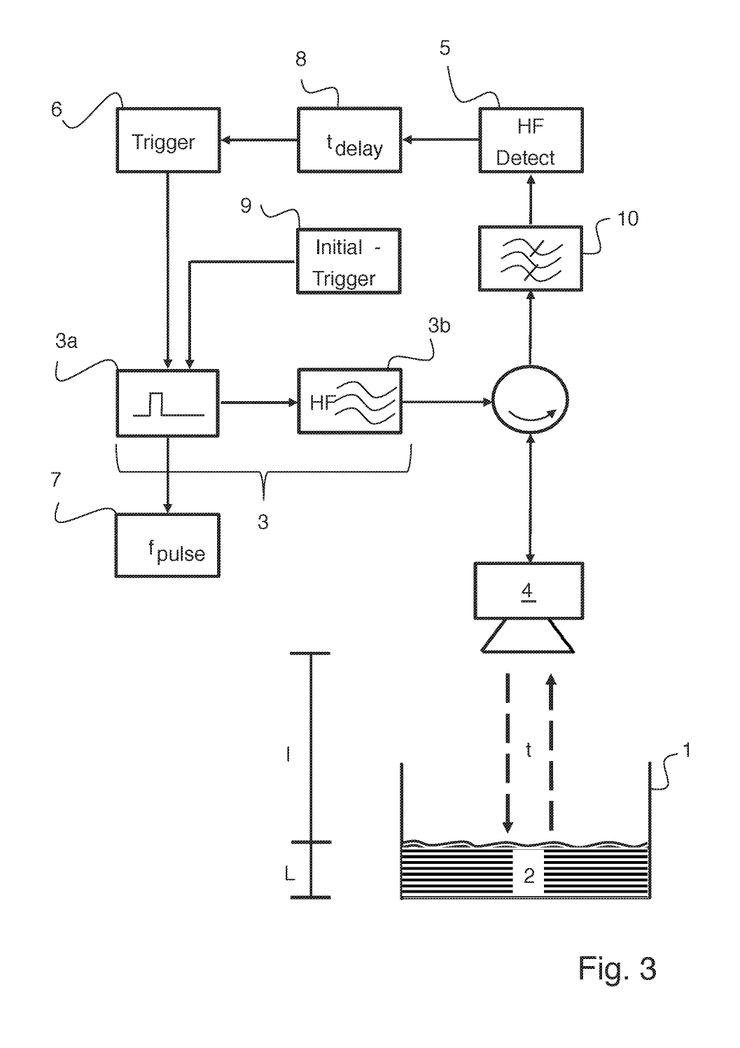

FIG. 3 an expanded fill-level measuring device having a modulation unit,

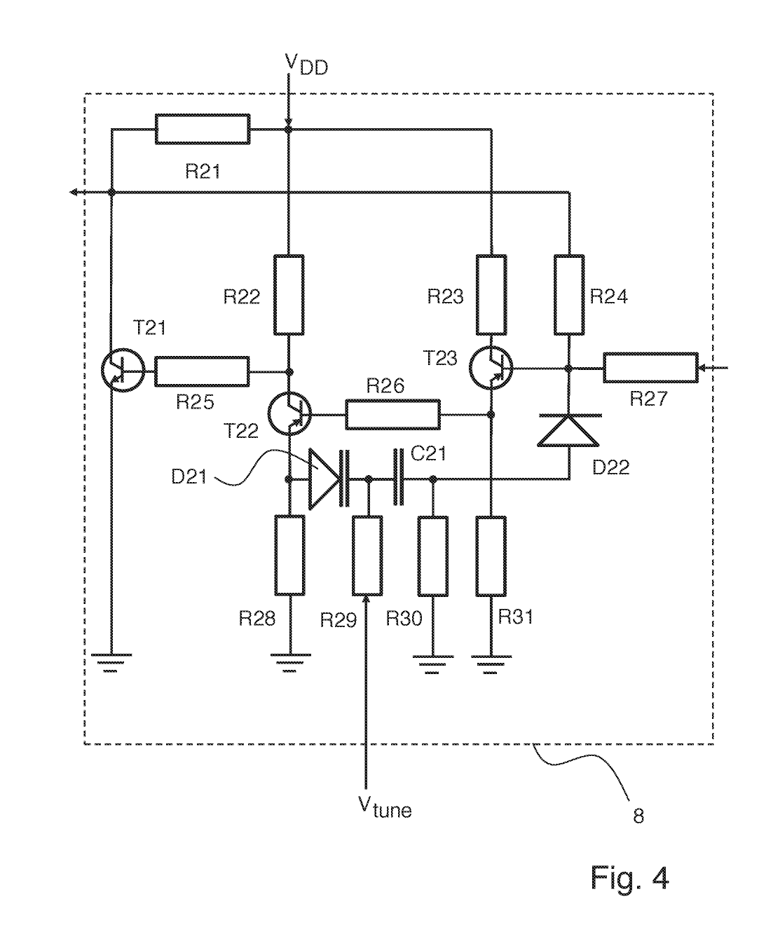

FIG. 4 an analog form of embodiment of the modulation unit,

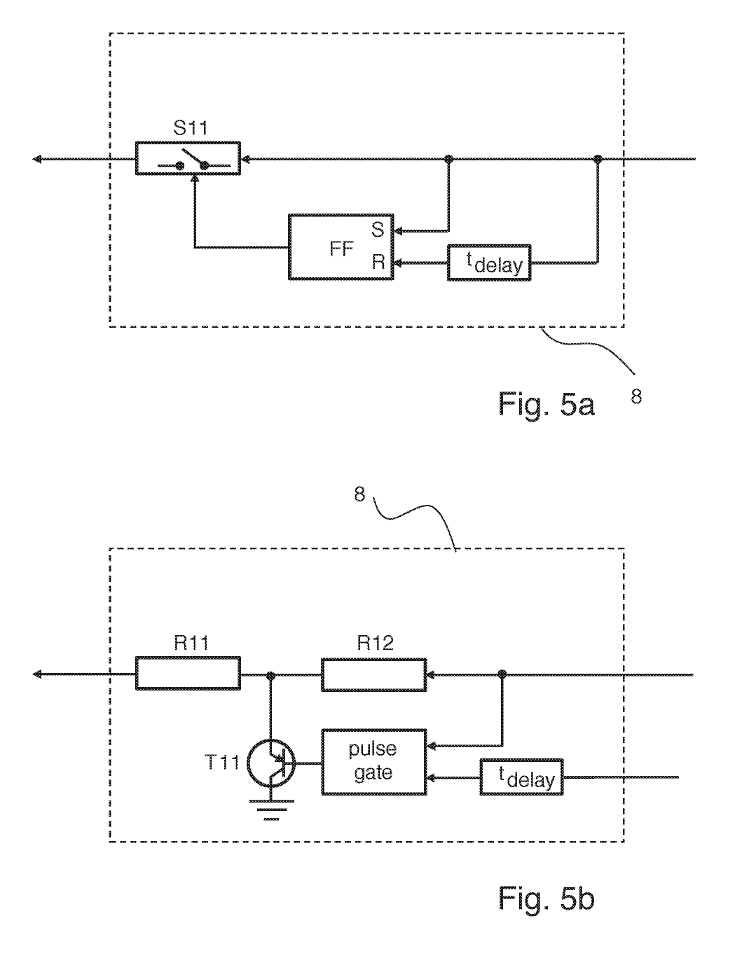

FIG. 5a a digital embodiment of the modulation unit,

FIG. 5b a second digital embodiment of the modulation unit,

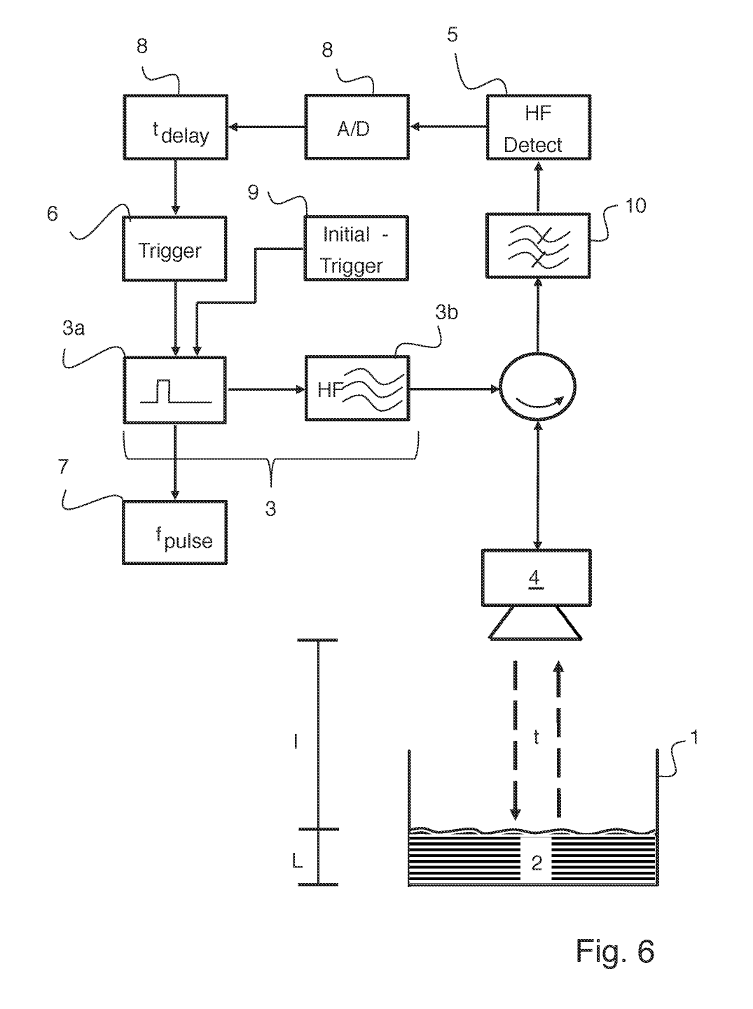

FIG. 6 an expanded fill-level measuring device having two antennas,

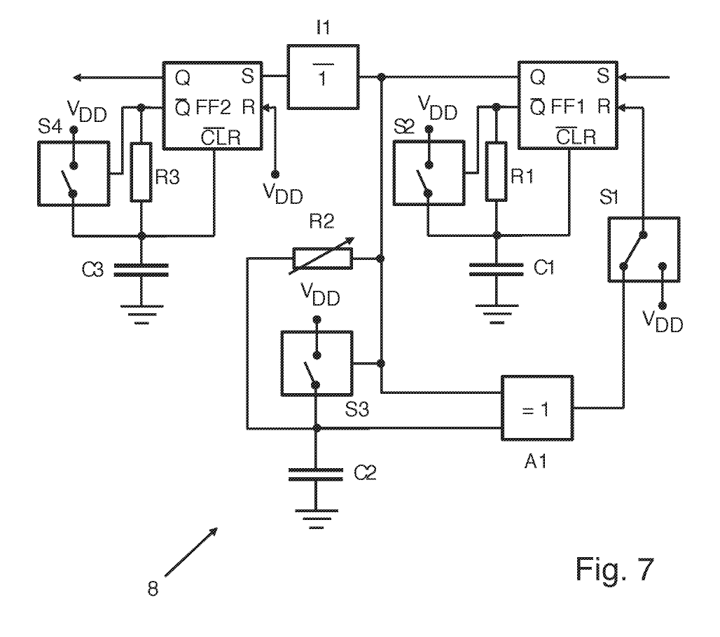

FIG. 7 an expanded fill-level measuring device having an amplifier,

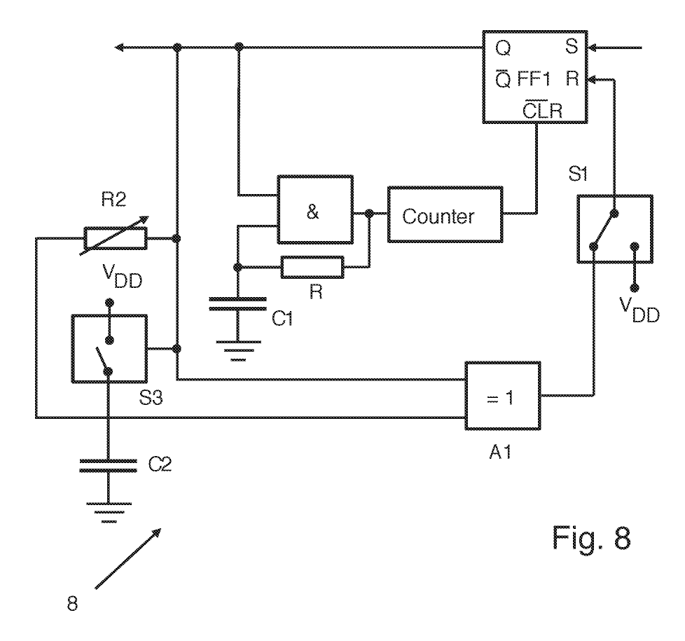

FIG. 8 an expanded fill-level measuring device having a digital delay unit,

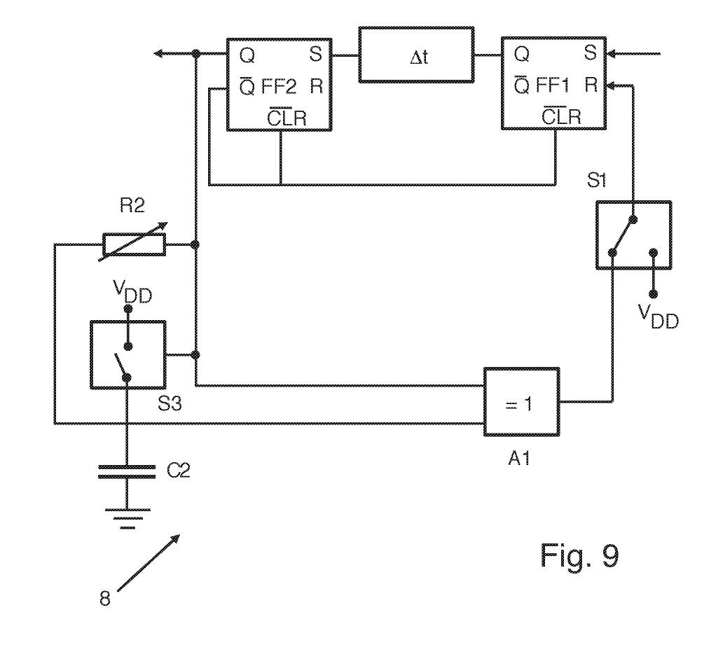

FIG. 9 another variant of a digital delay unit,

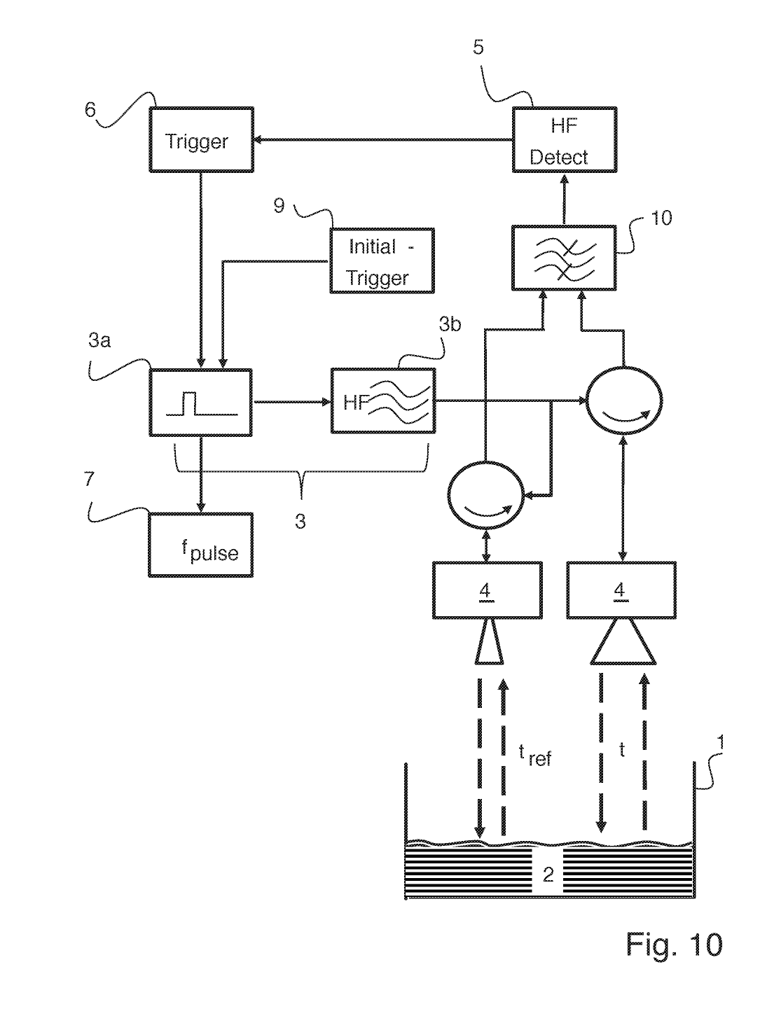

FIG. 10 an expanded fill-level measuring device having two antennas, and

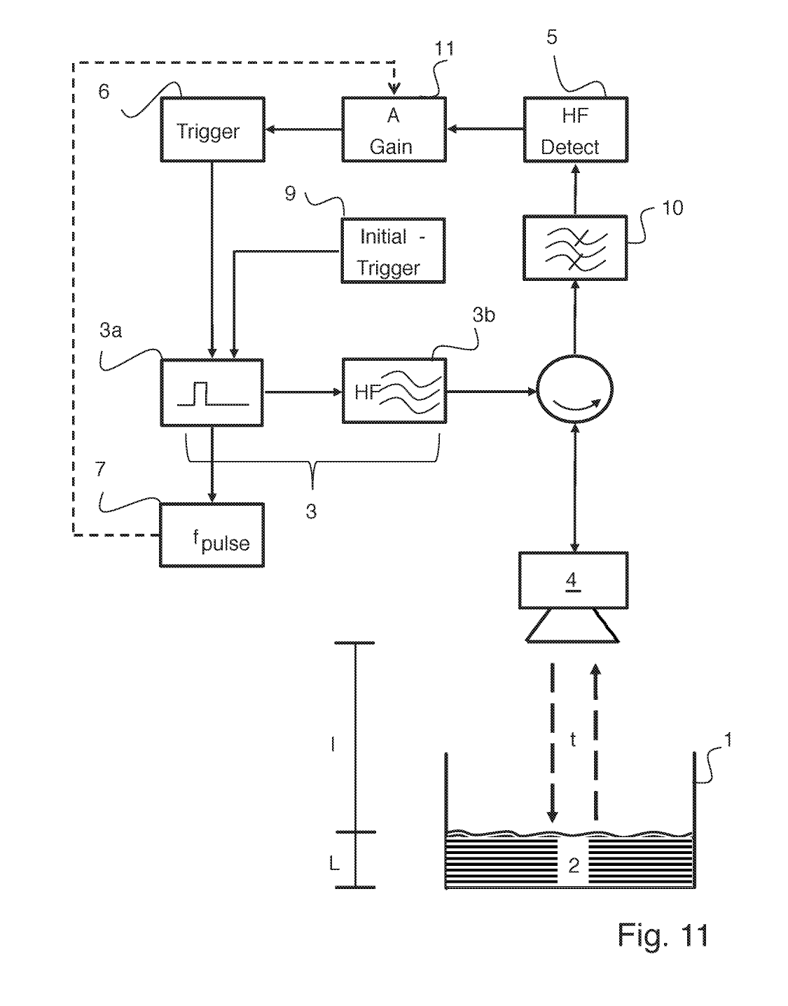

FIG. 11 an expanded fill-level measuring device having a supplemental amplifier.

Based on FIG. 1, in which a block diagram of a fill-level measuring device of the invention is shown, the operation of the method of the invention for measuring fill level L of a fill substance 2 located in a container 1 will be explained below.

The fill-level measuring device is located in the illustration of FIG. 1 at a predefined height I above the floor of the container 1. From the fill-level measuring device, microwave pulses are transmitted cyclically with a repetition frequency fₚᵤₗₛₑ through an antenna unit 4 toward the fill substance 2. The microwave pulses are excited via a pulse producing unit 3 and led via a duplexer into the antenna unit 4, where they are radiated toward the fill substance 2.

The pulse producing unit 3 is composed of two parts, such as is known from the state of the art of pulse radar: a pulse generator 3a and a high frequency generator 3b, which preferably has a low quality factor. In such case, the time length of the microwave pulse is controlled by the pulse generator 3a, for example, a pulse shortener or a monostable multivibrator. The control occurs, in such case, taking into consideration the response time, which results from the quality factor. The eigenfrequency of the microwave pulse lying in the GHz region is fixed by the high frequency generator 3b, for example, a Gunn- or semiconductor reflex oscillator. The triggering of the pulse generator 3a, thus the time of triggering of a microwave pulse, is controlled by a trigger 6. After reflection on the surface of the fill substance 2, the microwave pulse is detected at the antenna 4 after a travel time t dependent on the fill level L of the fill substance and led via the duplexer to a filter unit 10.

Alternatively to the example of an embodiment shown in FIG. 1, the antenna unit 4 can also be, instead of a single antenna, which works in the transmitting and receiving directions, two independent antennas for separated sending and receiving. In this case, no duplexer is necessary for separating the transmitted and reflected microwave pulses.

Filter unit 10 serves for filtering microwave pulses, which are received from the antenna unit 4, which, however, are not brought about by reflection on the surface of the fill substance 2, but, instead, for example, by disturbing bodies within the container 1 or by multi-echos. The filtering can, for example, be based thereon, that only microwave pulses with a signal strength lying in a predefined range are not filtered. This predefined range can be ascertained, for example, by one or more calibration measurements, in the case of which the signal strength is measured e.g. in the case of a defined fill level. After the filtering, the microwave pulse is registered by a detector unit 5, by which the trigger 6 is triggered.

Based on the fed back triggering of microwave pulses, in the case of which, according to the invention, a received microwave pulse triggers the following microwave pulse, the repetition frequency fₚᵤₗₛₑ adjusts as a function of travel time tin such a manner that repetition frequency fₚᵤₗₛₑ increases in the case of travel time t becoming shorter and lessens in the case of travel time t becoming longer. In this way, it is only necessary for ascertaining the fill level L to determine the arising repetition frequency fₚᵤₗₛₑ using an evaluating unit 7. In the case of the embodiment of the fill-level measuring device of the invention shown in FIG. 1, the repetition frequency fₚᵤₗₛₑ is, due to the direct feedback, proportional to the reciprocal of travel time t, to the extent that there is no relevant circuit internal travel time delay.

FIG. 2 details portions of the block diagram of FIG. 1. Shown are advantageous circuit options for implementing the detector unit 5, the evaluating unit 7 and the initial trigger 9. Detector unit 5 is composed of a rectifier diode D1 and a following lowpass filter, wherein the lowpass filter is composed of two series connected resistors R1, R2 and two ground connected capacitors C1 and C2.

The initial trigger 9 is embodied connected in parallel with the pulse generator 3a with two capacitors C3, C4, a diode D2 and a NOT gate G1. In such case, the diode D2 and the capacitor act to restart the measuring, in case no microwave pulse reflected on the surface of the fill substance was received and the cyclic transmission was accordingly interrupted.

The evaluating unit 7 shown in FIG. 2 is composed of a lowpass filter, which includes a grounded capacitor C5 and two resistances R3, R4 located in the output path. The resulting direct voltage value of the output signal Vₒᵤₜ is thereby proportional to the repetition frequency fₚᵤₗₛₑ, so that a discrete fill level L can thereby be associated with the output signal Vₒᵤₜ.

FIG. 3 shows an expanded embodiment of the fill-level measuring device illustrated in FIG. 1. The expansion concerns a modulation unit 8, which is arranged in the signal path between the detector unit 5 and the trigger 6. The modulation unit 8 delays triggering of the trigger 6 by a delay time t_{delay}. For the case, in which the time delay t_{delay} is set to a predefined value, the modulation unit 8 can be constructed in analog manner by logarithmically added line portions or based on digital conversion. In this case, the repetition frequency fₚᵤₗₛₑ is proportional to the reciprocal of the sum of travel time t and the delay time t_{delay}.

To the extent that through the modulation unit 8 no pure delay, but, instead, a masking of the received signal should be set as a function of time within the transmitting cycle, this can likewise be effected in analog or digital manner by the modulation unit 8. The masking as a function of time of the received signal, in which can be contained besides the reflected microwave pulse also disturbance echos, effects the masking of disturbance echos from the near range of the fill-level measuring device. In such case, the depth of the near range is defined by the value of the delay time t_{delay}.

FIG. 4 shows an analog circuit embodiment of the modulation unit 8 suitable for this. The circuit shown there is based on a cascade of three transistors T21, T22, T23, wherein the received signal is led via an input resistor R27 to the base, or the gate, of the input transistor T23. The tuning of the delay time t_{delay} occurs by an analog direct voltage Vₜᵤₙₑ across a resistor R29, whereby a corresponding potential on the output of a varactor diode D21 is set. The capacitor C21 serves, in such case, for isolating this potential from the rest of the circuit. For the case, in which the delay time t_{delay} is not configurable, but, instead, is pre-set by the circuit, this can occur via a corresponding dimensioning of a capacitor. In this case, the varactor diode D21 is shunted out or omitted, and the resistor R29 is absent.

In order that the high pulse frequency fₚᵤₗₛₑ be right, it is advantageous that the transistors T21, T22, T23 be discrete bipolar transistors, since they generally have a faster response time than MOS-FET transistors.

Alternatively to an analog implementation, masking of the received signal as a function of time can also be performed on a digital basis. Two embodiments of the modulation unit 8 suitable for this are shown in FIGS. 5a and 5b.

In the case of the circuit shown in FIG. 5a, the masking occurs via a switch S11, which is switched by a flip-flop FF. The input signals S, R of the flip-flop are, in such case, formed by the received signal and the received signal delayed with t_{delay}.

In the case of the variant of the modulation unit 8 shown in FIG. 5b, the masking of the received signal is achieved by drawing the received signal to ground through a transistor T11. Control of the transistor T11 occurs, in such case, via a pulse gate, whose inputs are supplied by the received signal and the received signal delayed with t_{delay}.

The variants shown in FIGS. 5a and 5b for digital masking of the received signal assume that the received signal has a discrete valued voltage level. This means a corresponding digitizing of the received signal before the modulation unit 8, such as is shown in FIG. 6.

FIGS. 7 to 9 show examples of embodiments of the modulation unit 8, in the case of which a digitizing of the received signal is performed by a gate circuit located upstream. In such case, the gate circuit is composed of a flip-flop FF1, two switches S1, S3, an AND gate A1, a potentiometer R2 and a capacitor C2.

Depending on switch position of the switch S1, the flip-flop FF1 can be triggered by the received signal or a reference pulse (in the illustrated switch position, triggering is by the received signal). A variable dead time of the flip-flop FF1 can be effected by adjusting the potentiometer R2.

The actual time delay t_{delay} is set by the discharge curve of a resistor R1 and a capacitor C1. In such case, the received signal is discharged via the resistor R1 and the capacitor C1, until the level falls below a predefined threshold.

In the case of the embodiment illustrated in FIG. 7, the time delay t_{delay} is achieved by a cascaded construction. Analogously to the first flip-flop FF1, the switch S2, the resistor R1 and the capacitor C1, a second flip-flop FF2, a further RC unit R3, C3 and a further switch S4 follows with the same function.

Instead of the variant shown in FIG. 7 for implementing the time delay by an RC unit R1, C1 and S2, and R3, C3 and S4, it is also possible to achieve the time delay t_{delay} by a digital counter, such as shown in FIG. 8. In this case, after detection of the received signal by the flip-flop FF1, the AND-gate oscillator turns on and counts up to a predetermined counter reading. Upon reaching this counter value, a reset signal is produced by the counter and the flip-flop is, thus, reset.

A third variant for implementing the time delay t_{delay} is shown in FIG. 9. In the case of this variant, a delay line Δt for delay in the ns-region, for example, a logic-IC suitable for this or an acoustic delay line, is applied. After receipt of the received signal by the first flip-flop FF1, a signal is produced on its output Q, wherein this is delayed by the delay line Δt. After expiration of the time delay t_{delay}, a second flip-flop is operated and a reset signal produced for the two flip-flops FF1, FF2.

FIG. 10 shows an expanded embodiment of the fill-level measuring device illustrated in FIG. 1. In contrast to the construction shown in FIG. 1, the antenna unit 4 comprises two transmitting and receiving antennas, which are operated separately from the pulse producing unit 3 via two duplexers. The received signals received by the two antennas are, in the case of this embodiment, filtered in the filter unit 10 by an AND logic. In this way, likewise a suppressing of disturbance echos can be achieved. This is effected by using the additional, second antenna to transmit a second microwave pulse at the same time as the first microwave pulse toward the fill substance. In such case, when the travel time t_{ref} of the second microwave pulse does not approximately equal the travel time t of the first microwave pulse, the received microwave pulse is filtered out by the AND logic.

In order to maximize the effectiveness of this variant, the two antennas of the antenna unit are oriented in such a manner that they register radiation regions, which are as different as possible. In this way, it is achieved that the antennas receive, besides the microwave pulse reflected from the surface of the fill substance 2, not the same disturbance echos. As a result, the disturbances echos are filtered out by the AND logic gate of the filter unit 10. Based on this measure, the embodiment shown in FIG. 10 increases the robustness of the fill-level measuring device vis-à-vis disturbance echos.

The embodiment of the fill-level measuring device of the invention shown in FIG. 11 is distinguished by an additional amplifier 11, which is arranged in the receiving path between the detector unit 5 and the trigger 6. In such case, the amplification A is controlled based on the repetition frequency fₚᵤₗₛₑ. Advantageously, amplifier 11 is controlled in such a manner that the amplification A is increased in the case of repetition frequency fₚᵤₗₛₑ becoming lower, and that the amplification A is lessened in the case of repetition frequency fₚᵤₗₛₑ becoming higher. Especially in the case of short distances or strongly reflecting surfaces, it can be, is, advantageous that the amplification be set in such a manner that the amplifier 11 has a signal attenuating effect. In the sense of the invention, an equally controlled amplifier can naturally also be arranged in the sending path.

A correspondingly controlled amplifier 11 can suppress an overdriving of the received microwave pulses, when these are very strongly reflected, for example, due to high fill levels. Likewise thereby, in the case of low fill levels and correspondingly weakly reflected microwave pulses, a sufficient signal strength of the received signal is assured. On the whole, this type of control contributes also to a lessened power consumption of the fill-level measuring device. This is especially relevant in the case of field devices in process automation, where very high requirements exist for explosion safety, whereby the maximum allowed power consumption is strongly limited.

### LIST OF REFERENCE CHARACTERS

1 container

2 fill substance

3 pulse producing unit

4 antenna unit

5 detector unit

6 trigger

7 evaluating unit

8 modulation unit

9 initial trigger

10 filter unit

11 amplifier

fₚᵤₗₛₑ repetition frequency

L fill level

t travel time

t_{delay} time delay

t_{ref} travel time

1-13. (canceled)

14. A method for measuring a fill level of a fill substance in a container using microwave pulses, comprising:
transmitting a first microwave pulse toward the fill substance, wherein the first microwave pulse is reflected by a surface of the fill substance;
receiving a first reflected microwave pulse after a travel time dependent on the fill level;
cyclically repeating the transmitting and the receiving at a repetition frequency, wherein the repetition frequency is a function of the travel time such that the repetition frequency increases when the travel time becomes shorter and decreases when the travel time becomes longer; and
determining the fill level based on the repetition frequency.

15. The method as claimed in claim 14, wherein the repetition frequency is proportional to a reciprocal of the travel time.

16. The method as claimed in claim 14, wherein the repetition frequency is proportional to a reciprocal of a sum of the travel time and a delay time.

17. The method as claimed in claim 14, further comprising:
transmitting an initiating microwave pulse when starting the measuring or when no microwave pulse reflected by the surface of the fill substance is received within a predetermined time interval.

18. The method as claimed in claim 14, further comprising:
determining whether the first reflected microwave pulse is the first transmitted microwave pulse reflected by the surface of the fill substance by determining a signal strength of the first reflected microwave pulse and filtering out the first reflected microwave pulse when the signal strength is outside a predefined range.

19. The method as claimed in claim 14, further comprising:
transmitting a second microwave pulse toward the fill substance at the same time as transmitting the first microwave pulse;
receiving a second reflected microwave pulse;
checking whether the first reflected microwave pulse is the first microwave pulse reflected by the surface of the fill substance by comparing a travel time of the second reflected microwave pulse with a travel time of the first reflected microwave pulse and filtering out the first reflected microwave pulse and the second reflected microwave pulse when the travel time of the second reflected microwave pulse does not approximately correspond to the travel time of the first reflected microwave pulse.

20. The method as claimed in claim 14, further comprising:
amplifying a microwave pulse to be transmitted and/or a received microwave pulse such that the amplification is increased when the repetition frequency becomes lower and the amplification is decreased when the repetition frequency becomes higher.

21. A fill-level measuring device, comprising:
a pulse producing unit embodied to produce microwave pulses;
at least one antenna unit embodied to transmit and/or to receive microwave pulses;
a detector unit embodied to detect reflected microwave pulses;
a trigger embodied to clock trigger the pulse producing unit as a function of a travel time of a microwave pulse produced by the pulse producing unit, transmitted by the at least one antenna, reflected by a reflecting surface of a fill substance, received by the at least one antenna, and detected by the detector unit, wherein the travel time is the time of the pulse travelling from the at least one antenna to the reflecting surface and back to the at least one antenna; and
an evaluating unit configured to determine a repetition frequency and to determine a fill level based on the repetition frequency, wherein the repetition frequency is the frequency at which the detector unit detects the reflected microwave pulse and causes the pulse producing unit to produce a further microwave pulse.

22. The fill-level measuring device as claimed in claim 21, further comprising:
a modulation unit configured to delay triggering of the pulse producing unit by a delay time.

23. The fill-level measuring device as claimed in claim 21, further comprising:
an initial trigger for initiating triggering of the pulse producing unit.

24. The fill-level measuring device as claimed in claim 21, further comprising:
at least one filter unit configured to test whether a received microwave pulse is a microwave pulse reflected by the surface of the fill substance,
wherein the at least one filter unit is configured to test a signal strength of the received microwave pulse and to filter out the received microwave pulse if the signal strength is outside a predefined range, or
wherein the at least one filter unit is configured to determine a difference between a travel time of a first received microwave pulse and a travel time of a second received microwave pulse that were produced and transmitted simultaneously, and to filter out the first received microwave pulse and the second received microwave pulse when the first travel time and the second travel time do not approximately correspond.

25. The fill-level measuring device as claimed in claim 21, further comprising:
at least one amplifier configured to amplify the microwave pulses to be transmitted and/or the reflected microwave pulses.

26. The fill-level measuring device as claimed in claim 25, wherein the amplifier is configured to amplify the reflected microwave pulses such that amplification is increased when the repetition frequency becoming lower, and that amplification is decreased when the repetition frequency becoming higher.
